(19) United States
(12) Patent Application Publication
(10) Pub. No.: US 2010/0086904 A1
(43) Pub. Date: Apr. 8, 2010

(54) MODULAR ORNAMENTAL MAGNET ASSEMBLY

(75) Inventor: Marion LANKTREE, Ottawa (CA)

Correspondence Address: SIMPSON & SIMPSON, PLLC, 5555 MAIN STREET, WILLIAMSVILLE, NY, 14221-5406, US

(73) Assignee: Umbra LLC, Buffalo, NY (US)

(21) Appl. No.: 12/541,431

(22) Filed: Aug. 14, 2009

Related U.S. Application Data
(63) Continuation-in-part of application No. 12/286,986, filed on Oct. 4, 2008.

(51) Int. Cl. G09B 25/00

(52) U.S. Cl. 434/73

(57) ABSTRACT

A modular magnet assembly including a first module having a first whorl of members extending from a first magnet and defining a first cavity, and a second module having a second whorl of members extending from a second magnet and defining a second cavity, wherein the second module is stackable on the first module such that the second whorl is nested within the first cavity and the first magnet and the second magnet are aligned along an axis, and the first magnet and the second magnet and operatively arranged to magnetically secure the second module to the first module when the second whorl is nested within the first cavity.

### CROSS-REFERENCE TO RELATED APPLICATIONS

This is a continuation-in-part of U.S. patent application Ser. No. 12/286,986 filed on Oct. 4, 2008, which application is incorporated herein by reference in its entirety.

### FIELD OF THE INVENTION

The invention broadly relates to ornamental magnets, more specifically to ornamental magnet assemblies, and even more particularly to modular, ornamental magnet assemblies resembling flowers.

### BACKGROUND OF THE INVENTION

Ornamental magnets, such as refrigerator magnets, are well known. Generally, such magnets are simple, aesthetically pleasing articles of manufacture fixed to magnets. Commonly, ornamental are used as decorations and to secure items to vertical surfaces such as such as refrigerators doors. The articles of manufacture tend to be simple molded plastic pieces in the form of items such as animals, letters, and flowers, or even simpler forms, such as placards with matter printed thereon. The aesthetic appeal of prior ornamental magnets is limited to that which is provided by the particular article of manufacture, be it a simple form or placard.

### BRIEF SUMMARY OF THE INVENTION

Generally, the present invention is a modular magnet assembly comprising: a first module comprising a first whorl of members extending from a first magnet and defining a first cavity; and, a second module comprising a second whorl of members extending from a second magnet and defining a second cavity, wherein the second module is stackable on the first module such that the second whorl is nested within the first cavity and the first magnet and the second magnet are aligned along an axis, and the first magnet and the second magnet and operatively arranged to magnetically secure the second module to the first module when the second whorl is nested within the first cavity.

In one aspect of the invention, the present invention modular magnet assembly comprises a plurality of modules of different sizes, which are stackable along a central axis of rotation in order of progressively decreasing size, i.e., from largest to smallest. Each module generally comprises a whorl of members, and gaps defined therebetween, which extend radially from a magnet. The members of each whorl preferably curve in a coaxial direction and, thereby, define a cavity. When the modules are stacked in order of progressively decreasing size, each stacked module is nested within the cavity of the module upon which it is stacked. Additionally, when the modules are in a stacked and nested arrangement, the magnets of the modules are axially aligned and magnetically attracted to each other. Such magnetic attraction is preferably of sufficient strength to secure the plurality of modules in the stacked and nested arrangement.

In another aspect, each whorl resembles leaves or petals of a flower radially arranged around a central axis. In another aspect, the modules are stackable such that the petal-shaped members of each layer axially are aligned with the gaps of adjacent layers, thereby giving the stack the appearance of alternating whorls of petals or sepals, an arrangement which is frequently found in the calyx and corolla of natural flowers, such as magnolias and orchids. In a preferred embodiment, each layer comprises a whorl of four, petal-shaped members which extend radially from a central axis, define four gaps therebetween, and curve coaxially. The layers are operatively arranged to serve as magnetic holders of items or decorations both separately and when stacked.

It is an object of the present invention to provide an ornamental magnet assembly comprising a plurality of modules which may be magnetically coupled to each other in an aesthetically pleasing assembly, or used as separate, simple ornamental magnets.

It is a further object of the invention to provide such an ornamental magnet assembly comprising a plurality of modules which, when magnetically coupled to each other, are arranged to form a complex flower structure having layers of whorls similar to those found in magnolias, orchids, and the like.

These and other objects and advantages of the present invention will be readily appreciable from the following description of preferred embodiments of the invention and from the accompanying drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1 is a top, perspective view of a preferred embodiment of the present invention modular magnet assembly arranged as a plurality of nested modules;

FIG. 2 is a top, plan view of the modular magnet assembly showing the members and gaps of every module in axial alignment;

FIG. 3 is a top, plan view of the modular magnet assembly showing the members and gaps of every other module rotated into axial alignment;

FIG. 4 is an exploded perspective view of the modular magnet assembly;

FIG. 5 is a bottom perspective view the modular magnet assembly;

FIG. 6 is a side, elevational view of the modular magnet assembly;

FIG. 7 is a top, plan view of the plurality of modules separated and affixed to a vertical surface;

FIG. 8 is a side, elevational view of the plurality of modules separated;

FIG. 9 is a bottom, plan view of the plurality of modules separated;

FIG. 10 is a cross-sectional view taken generally along line 10-10 in FIG. 7;

FIG. 11 is a top, perspective view of a second embodiment of the present invention modular magnet assembly arranged as a plurality of nested modules;

FIG. 12 is a top, plan view of the second embodiment, showing the members and gaps of every module in axial alignment;

FIG. 13 is a top, plan view of the second embodiment showing various members and gaps of its modules rotated into axial alignment;

FIG. 14 is an exploded perspective view of the second embodiment;

FIG. 15 is a side, elevational view of the second embodiment;

FIG. 16 is a back, elevational view of the second embodiment;

FIG. 17 is a top, plan view of the plurality of modules of the second embodiment separated and affixed to a vertical surface;

FIG. 18 is a front, elevational view of the plurality of modules of the second embodiment separated;

FIG. 19 is a bottom, plan view of the plurality of modules of the second embodiment separated; and,

FIG. 20 is a cross-sectional view taken generally along line 20-20 in FIG. 17.

### DETAILED DESCRIPTION OF THE INVENTION

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims. Unless defined otherwise, all technical and scientific terms used herein have the same meaning as commonly understood to one of ordinary skill in the art to which this invention belongs.

It should be appreciated that the terms “central axis” or “axis of rotation”, when used herein, refer to a line about which a three-dimensional body, e.g., the present invention modular ornamental magnet assembly, is substantially symmetrical, and such terms may be used interchangeably as appearing in the specification and claims. Moreover, the terms “axial” or “coaxial” are directional terms and refer to that which is situated on, along, or in the direction of the central axis or axis of rotation, and such terms may be used interchangeably as appearing in the specification and claims. The term “radial” refers to an arrangement parts extending from the central axis, preferably uniformly, like rays or radii.

It should also be appreciated that the term “whorl”, when used herein, refers to a circular arrangement of like parts, such as leaves, petals, or wings, around a point on an axis. In other words, the term refers a plurality of like parts, such as leaves, petals, or wings, extending radially from a central axis or axis of rotation.

It should also be appreciated that the verb “to nest”, when used herein, refers to fitting or placing one object within another object. The term “nested” refers to an object placed or fitted within another object, especially in a compact, stacked formation. Additionally, the term “nestable” refers to a structural arrangement wherein one object is arranged to be placed or fitted within another object.

Although many methods, devices or materials similar or equivalent to those described herein can be used in the practice or testing of the invention, the preferred methods, devices, and materials are now described.

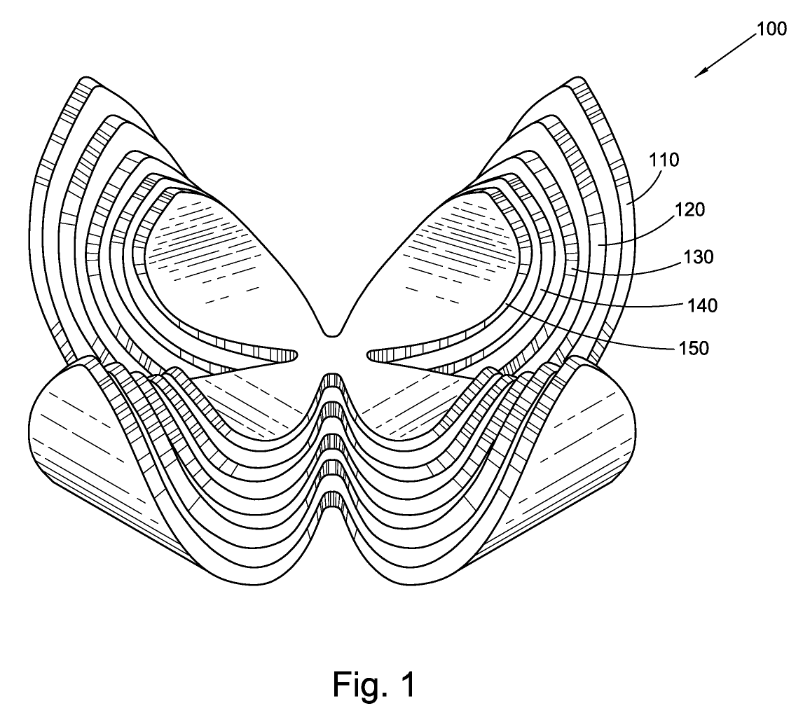

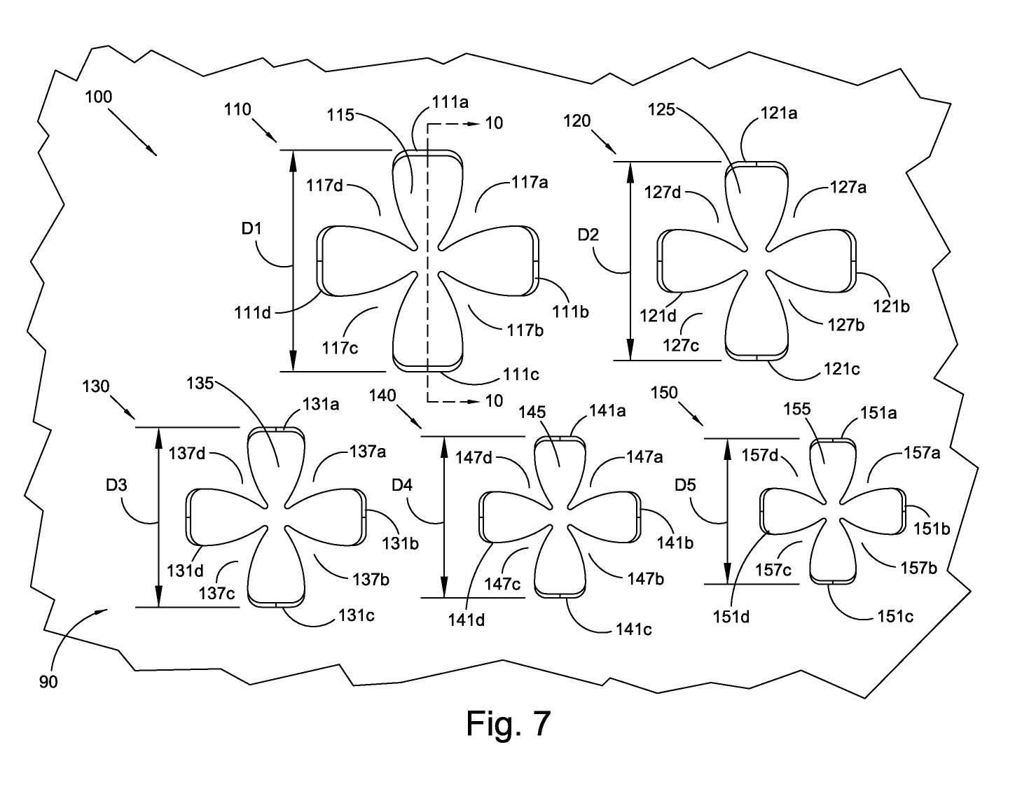

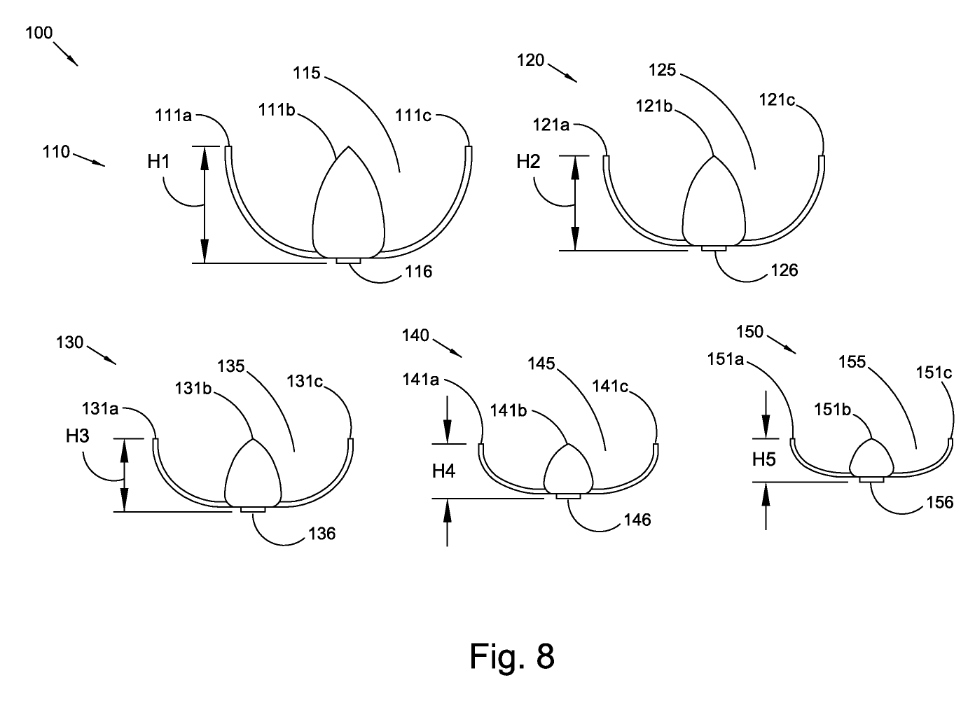

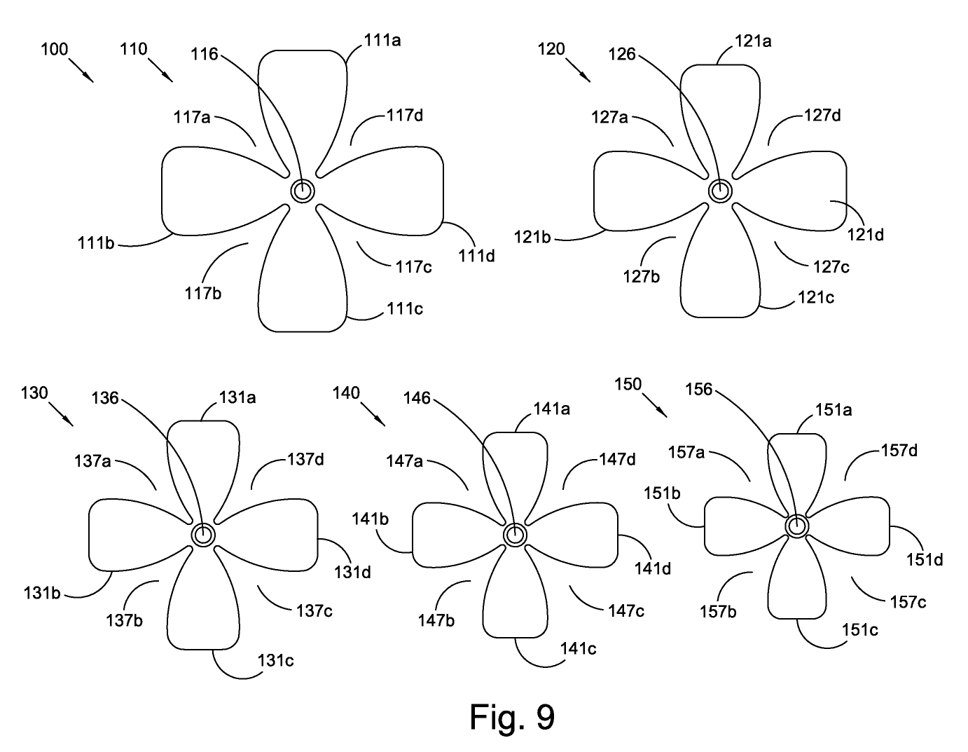

Adverting now to the figures, FIG. 1 is a top, perspective view of a preferred embodiment of the present invention modular magnet assembly, hereinafter referred to as magnet assembly 100. Magnet assembly 100 comprises a plurality of modules of different sizes, namely, first module 110, second module 120, third module 130, fourth module 140, and fifth module 150. In this embodiment, as described in further detail infra and shown in FIGS. 7-9, each module of magnet assembly 100 may be arranged as a whorl of generally uniform, petal-shaped members, and gaps defined therebetween, extending from a centrally arranged magnet.

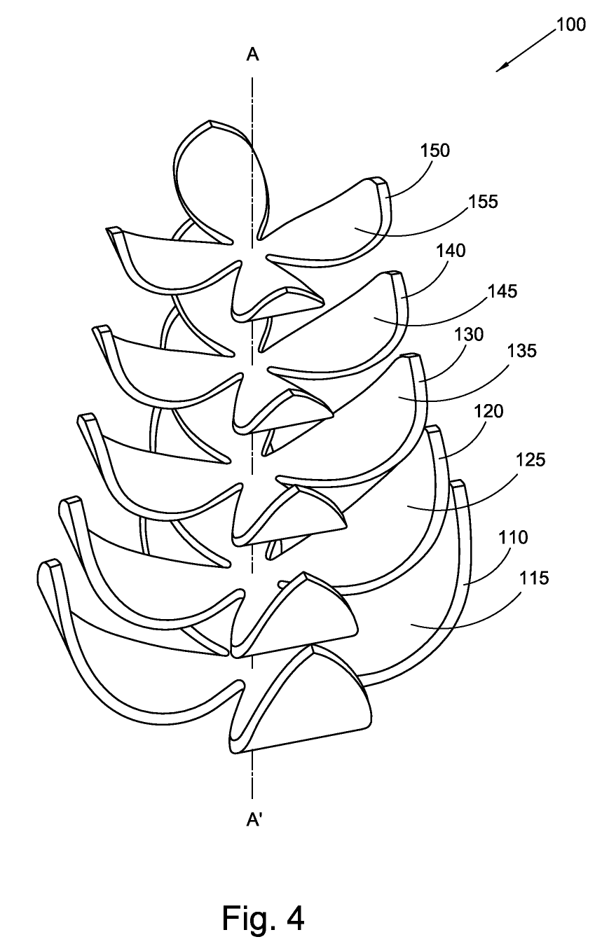

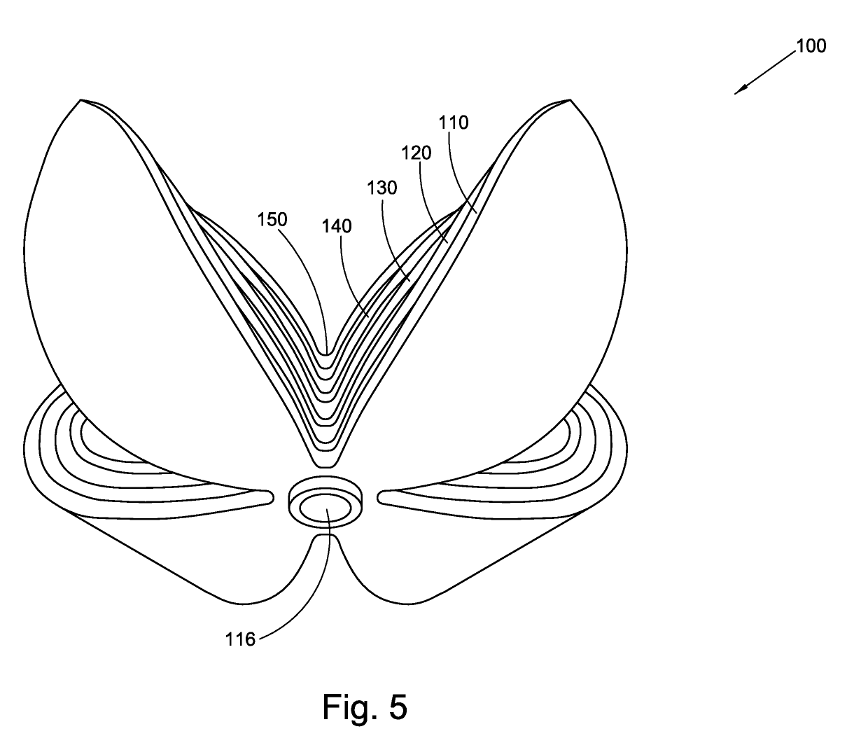

FIG. 4 shows the plurality of modules aligned along axis A-A′. As shown in this figure, the members of first module 110 curve in a coaxial direction and define a cavity 115; the members of second module 120 curve in a coaxial direction and define a cavity 125; the members of third module 130 curve in a coaxial direction and define a cavity 135; the members of fourth module 140 curve in a coaxial direction and define a cavity 145; and, the members of fifth module 150 curve in a coaxial direction and define a cavity 155. As shown in FIGS. 1-6, the plurality of modules may be stacked and nested in order of progressively decreasing size along axis A-A′. Each stacked module is nested within the cavity of the module upon which it is stacked. In particular, fifth module 150 is stacked upon fourth module 140 and nested within cavity 145; fourth module 140 is stacked upon third module 130 and nested within cavity 135; third module 130 is stacked upon second module 120 and nested within cavity 125; and, second module 120 is stacked upon first module 110 and nested within cavity 115. First module 110, being the largest module, is not nestable within any other module and serves as the base of magnet assembly 100.

When the modules are in a stacked and nested arrangement, the magnets of the modules are axially aligned and magnetically attracted to each other. Such magnetic attraction is preferably of sufficient strength to secure the plurality of modules in the stacked and nested arrangement.

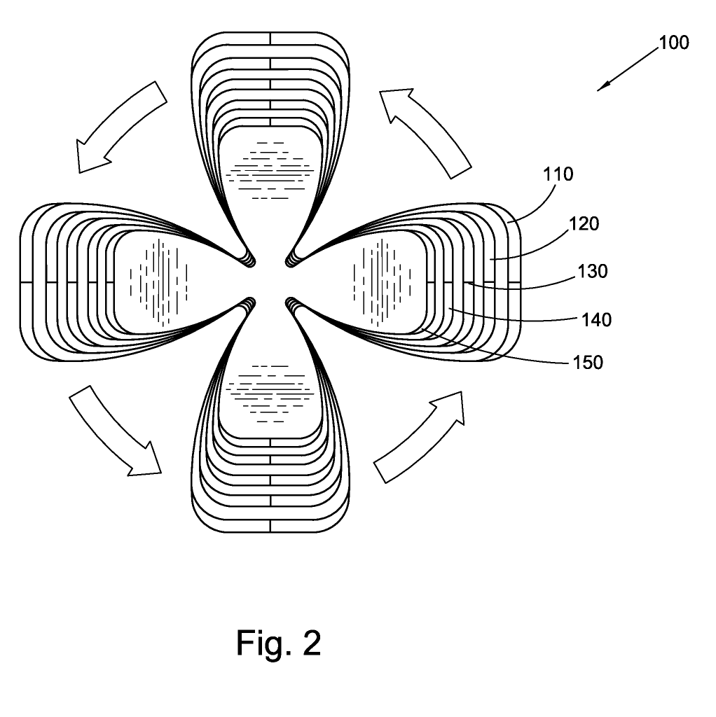

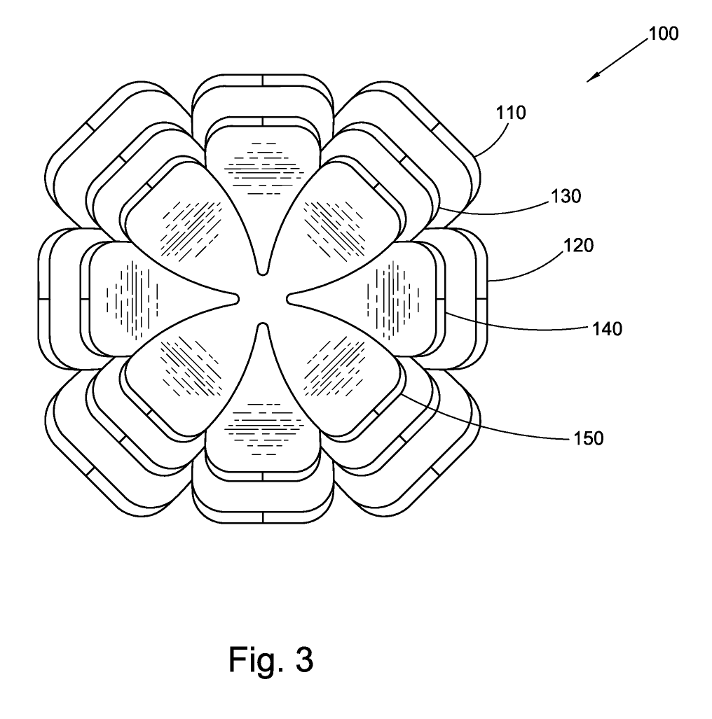

As shown in FIG. 2, the plurality of modules may be stacked and nested such that the respective members and gaps of every module are in axial alignment. As shown in FIG. 3 the plurality of modules may be stacked and nested such that the respective members and gaps of every other module are in axial alignment, i.e., the respective members and gaps of modules 110, 130, and 150 are in axial alignment, and the respective members and gaps of modules 120 and 140 are in axial alignment. Preferably, as indicated with the arrows in FIG. 2, whorls 110, 120, 130, 140, and 150 are rotatable when they are in a stacked and nested arrangement so that the members and gaps of each module may rotated in and out of alignment.

As shown in FIGS. 7-9, first module 110 comprises first plurality of members 111a-d, and first plurality of gaps 117a-d defined therebetween, extending radially from first magnet 116, which is arranged in the center of first module 110. As shown in the figures, each member of first plurality of members 111a-d includes a proximal end affixed to first magnet 116 and a distal end arranged opposite the proximal end. Additionally, first plurality of members 111a-d are preferably uniform, petal-shaped, curved in a coaxial direction as they extend from first magnet 116. Such curvature of first plurality of members 111a-d provides a generally concave top surface, which defines first cavity 115, and a convex bottom surface. In the embodiment shown in the figures, first magnet 116 is affixed to the proximal ends of first plurality of members 111a-d on the convex bottom surface.

First module 110 includes first diameter D1 and first height H1, which is defined by the longest axial distance between the distal end and the proximal end of any member of first plurality of members 111a-d. Since members 111a-d are substantially uniform, the distances between the distal end and the proximal end of each member each member 111a-d are substantially equal.

Second module 120 comprises second plurality of members 121a-d, and second plurality of gaps 127a-d defined therebetween, extending radially from second magnet 126, which is arranged in the center of second module 120. As shown in the figures, each member of second plurality of members 121a-d includes a proximal end affixed to second magnet 126 and a distal end arranged opposite the proximal end. Additionally, second plurality of members 121a-d are preferably uniform, petal-shaped, and curved in a coaxial direction as they extend from second magnet 126. Such curvature of second plurality of members 121a-d provides a generally concave top surface, which defines second cavity 125, and a convex bottom surface. In the embodiment shown in the figures, second magnet 126 is affixed to the proximal ends of second plurality of members 121a-d on the convex bottom surface.

Second module 120 includes second diameter D2 and second height H2, which is defined by the longest axial distance between the distal end and the proximal end of any member of second plurality of members 121a-d. Since members 121a-d are substantially uniform, the distances between the distal end and the proximal end of each member each member 121a-d are substantially equal.

Third module 130 module comprises third plurality of members 131a-d, and third plurality of gaps 137a-d defined therebetween, extending radially from third magnet 136, which is arranged in the center of third module 130. As shown in the figures, each member of third plurality of members 131a-d includes a proximal end affixed to third magnet 136 and a distal end arranged opposite the proximal end. Additionally, third plurality of members 131a-d are preferably uniform, petal-shaped, and curved in a coaxial direction as they extend from third magnet 136. Such curvature of third plurality of members 131a-d provides a generally concave top surface, which defines third cavity 135, and a convex bottom surface. In the embodiment shown in the figures, third magnet 136 is affixed to the proximal ends of third plurality of members 131a-d on the convex bottom surface.

Third module 130 includes third diameter D3 and third height H3, which is defined by the longest axial distance between the distal end and the proximal end of any member of third plurality of members 131a-d. Since members 131a-d are substantially uniform, the distances between the distal end and the proximal end of each member each member 131a-d are substantially equal.

Fourth module 140 comprises fourth plurality of members 141a-d, and fourth plurality of gaps 147a-d defined therebetween, extending radially from fourth magnet 146, which is arranged in the center of fourth module 140. As shown in the figures, each member of fourth plurality of members 141a-d includes a proximal end affixed to fourth magnet 146 and a distal end arranged opposite the proximal end. Additionally, fourth plurality of members 141a-d are preferably uniform, petal-shaped, and curved in a coaxial direction as they extend from fourth magnet 146. Such curvature of fourth plurality of members 141a-d provides a generally concave top surface, which defines fourth cavity 145, and a convex bottom surface. In the embodiment shown in the figures, fourth magnet 146 is affixed to the proximal ends of fourth plurality of members 141a-d on the convex bottom surface.

Fourth module 140 includes fourth diameter D4 and fourth height H4, which is defined by the longest axial distance between the distal end and the proximal end of any member of fourth plurality of members 141a-d. Since members 141a-d are substantially uniform, the distances between the distal end and the proximal end of each member each member 141a-d are substantially equal.

Fifth module 150 comprises fifth plurality of members 151a-d, and fifth plurality of gaps 157a-d defined therebetween, extending radially from fifth magnet 156, which is arranged in the center of fifth module 150. As shown in the figures, each member of fifth plurality of members 151a-d includes a proximal end affixed to fifth magnet 156 and a distal end arranged opposite the proximal end. Additionally, fifth plurality of members 151a-d are preferably uniform, petal-shaped, and curved in a coaxial direction as they extend from fifth magnet 156. Such curvature of fifth plurality of members 151a-d provides a generally concave top surface, which defines fifth cavity 155, and a convex bottom surface. In the embodiment shown in the figures, fifth magnet 156 is affixed to the proximal ends of fifth plurality of members 151a-d on the convex bottom surface.

Fifth module 150 includes fifth diameter D5 and fifth height H5, which is defined by the longest axial distance between the distal end and the proximal end of any member of fifth plurality of members 151a-d. Since members 151a-d are substantially uniform, the distances between the distal end and the proximal end of each member each member 151a-d are substantially equal.

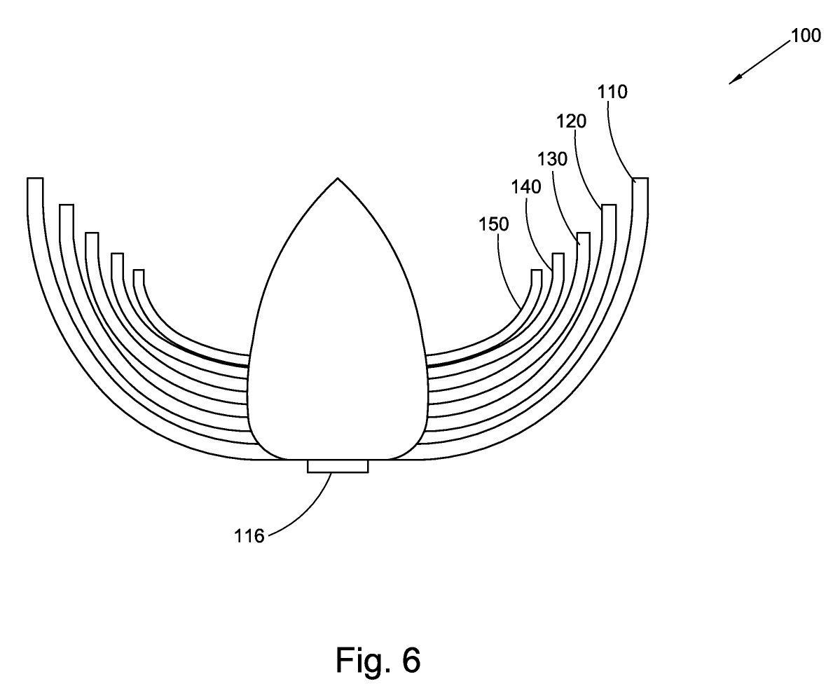

It should be appreciated that the plurality of modules are stackable and nestable in order of decreasing size, i.e., from largest to smallest, primarily because: D1 is greater than D2, D2 is greater than D3, D3 is greater than D4, and D4 is greater than D5; and, H1 is greater than H2, H2, is greater than H3, H3 is greater than H4, and H4 is greater than H5, as illustrated in FIG. 6.

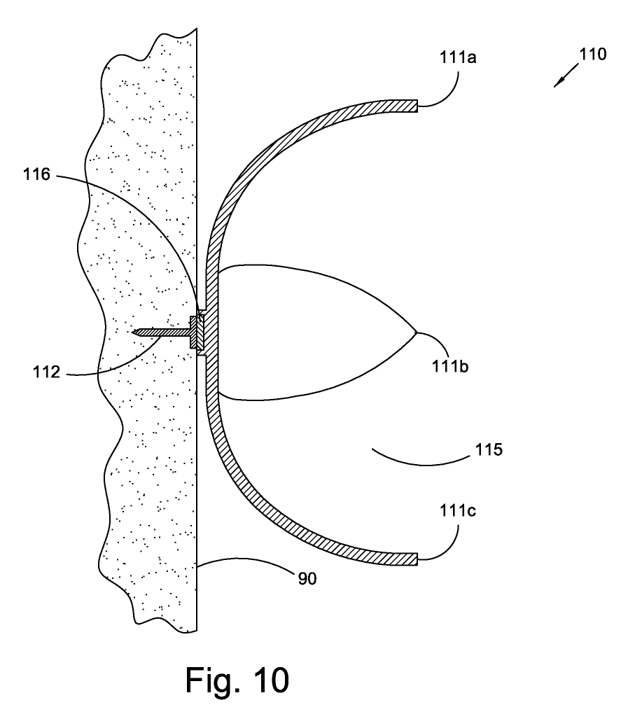

As magnet assembly 100 comprises a plurality of separate modules, each of which includes a magnet from which its members extend, each module may be secured to a surface by means of magnetic attraction between the magnet and the surface. For example, as shown in FIG. 7, first module 110, second module 120, third module 130, fourth module 140, and fifth module 150 are each secured to vertical surface 90 by means of a magnetic attraction between first magnet 116, second magnet 126, third magnet 136, fourth magnet 146, and fifth magnet 156, respectively, and a nail embedded in vertical surface 90, which nail comprises a magnetically attractable material, such as iron. For example, as shown in FIG. 10, first module 100 is secured to vertical surface 90 by means of a magnetic attraction between first magnet 116 and nail 112.

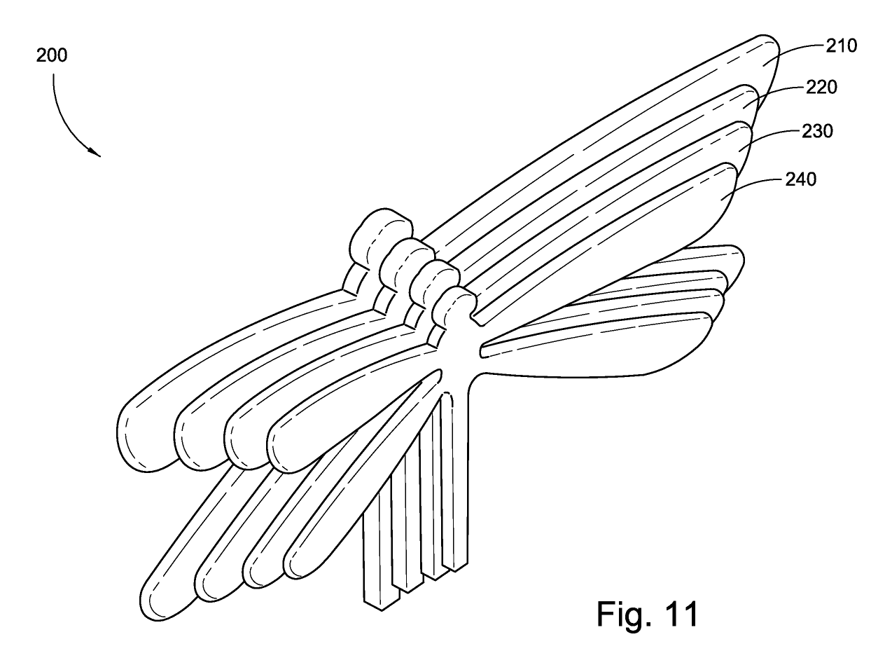

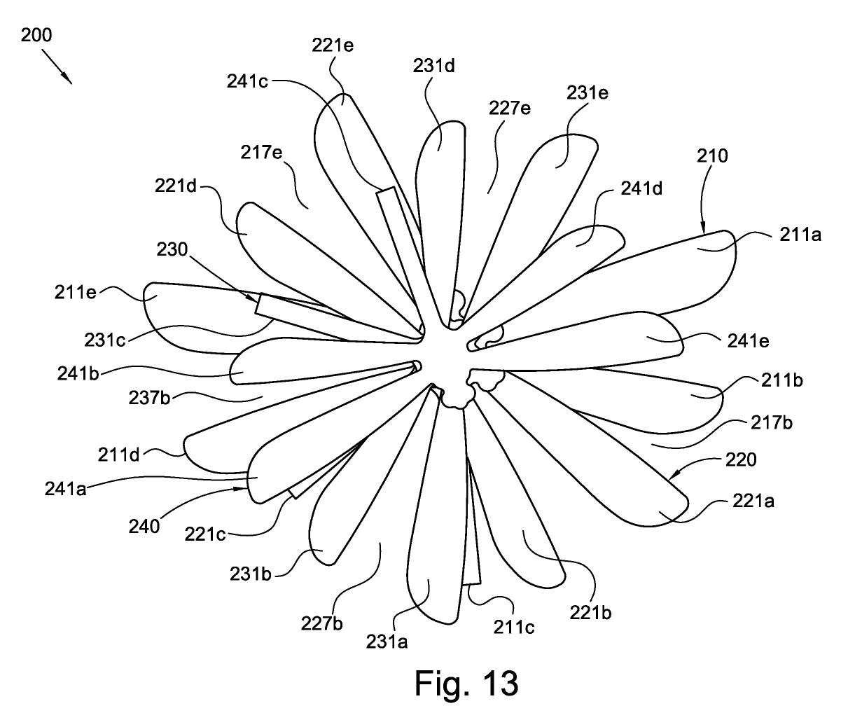

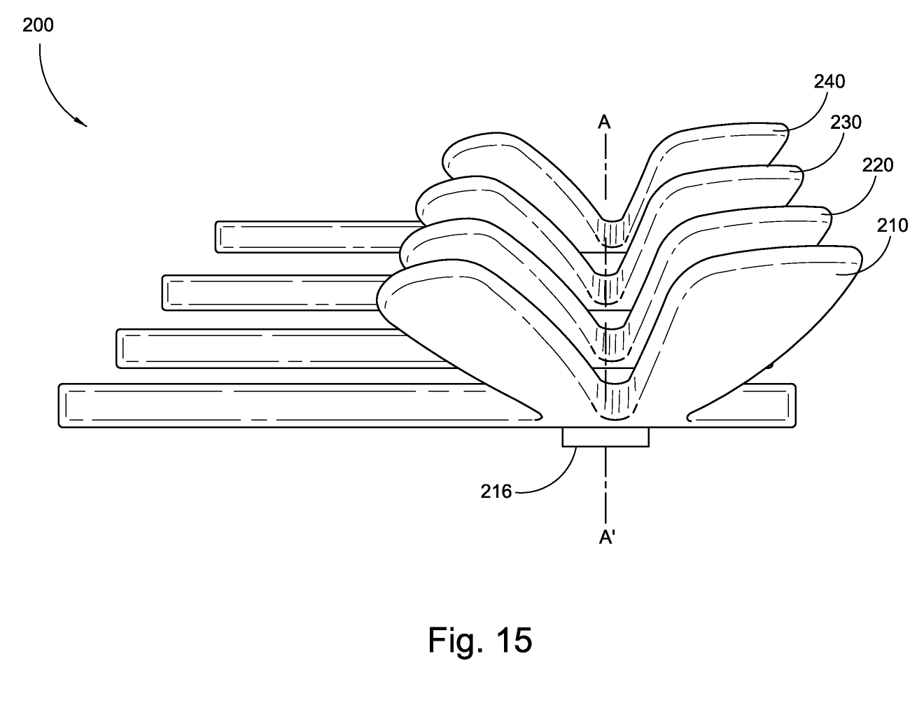

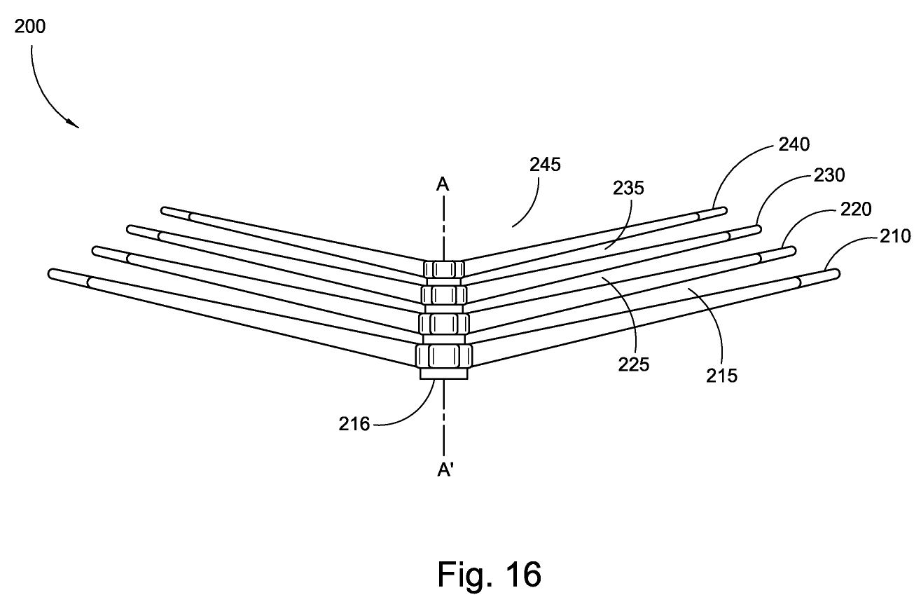

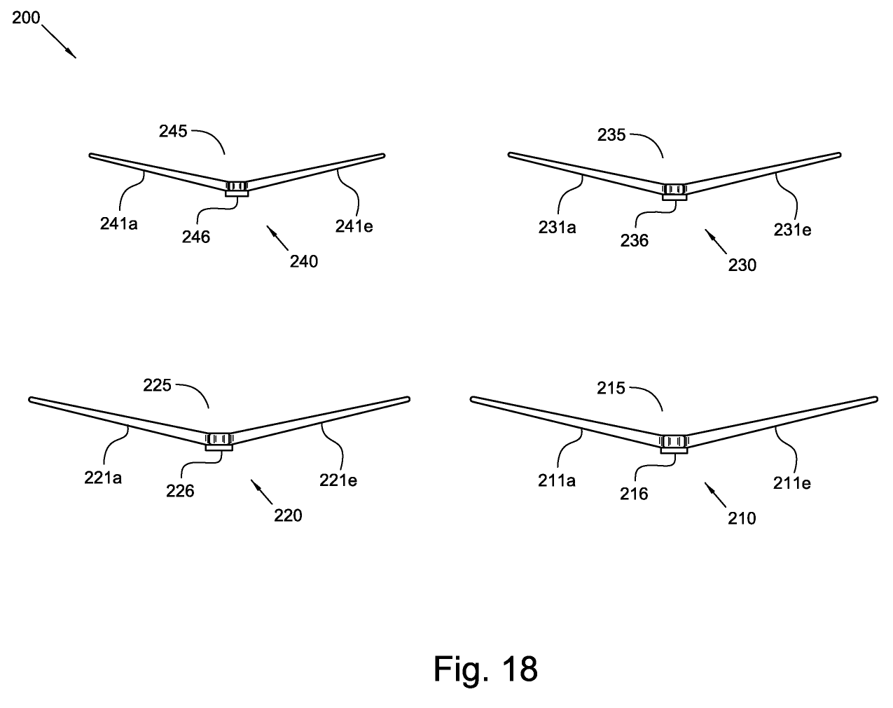

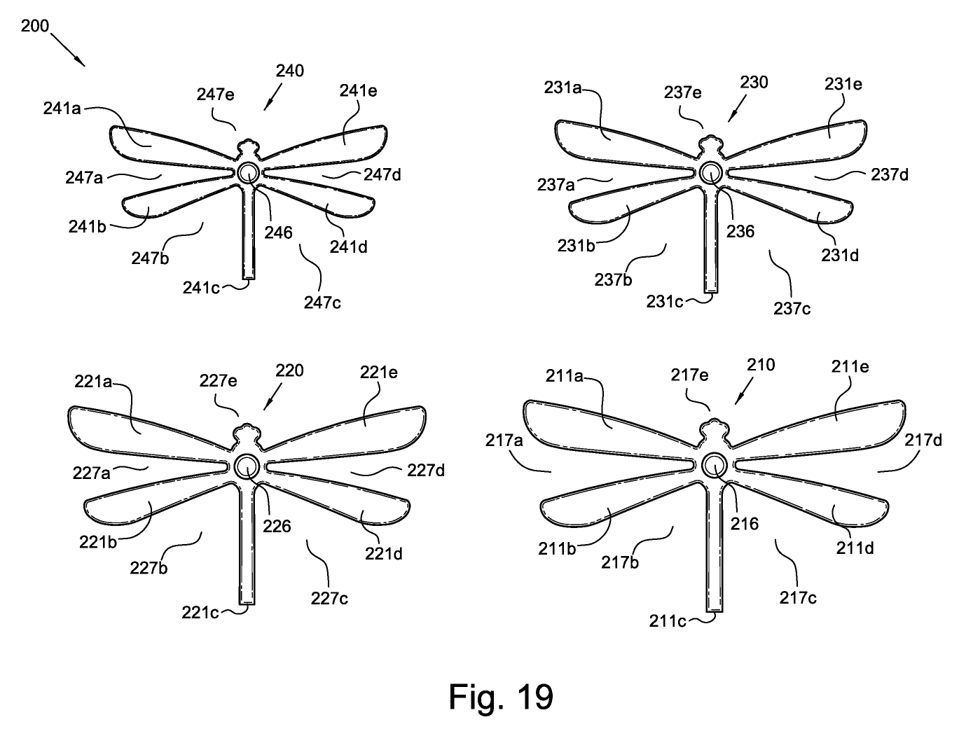

FIGS. 11-20 show a second embodiment of the present invention modular magnet assembly, hereinafter referred to as magnet assembly 200. FIG. 11 is a top, perspective view of a preferred embodiment of the present invention modular magnet assembly, hereinafter referred to as magnet assembly 200. Magnet assembly 200 comprises a plurality of modules of different sizes, namely, first module 210, second module 220, third module 230, and fourth module 240. In this embodiment, as described in further detail infra and shown in the figures, each of the modules of magnet assembly 200 is generally in the form of a dragonfly, which form includes petal-shaped wings and tail extending from a centrally arranged magnet. Moreover, when the modules of magnet assembly 200 are rotated, as shown in FIG. 13, the dragonfly form of the modules become obscured and the assembly resembles a flower.

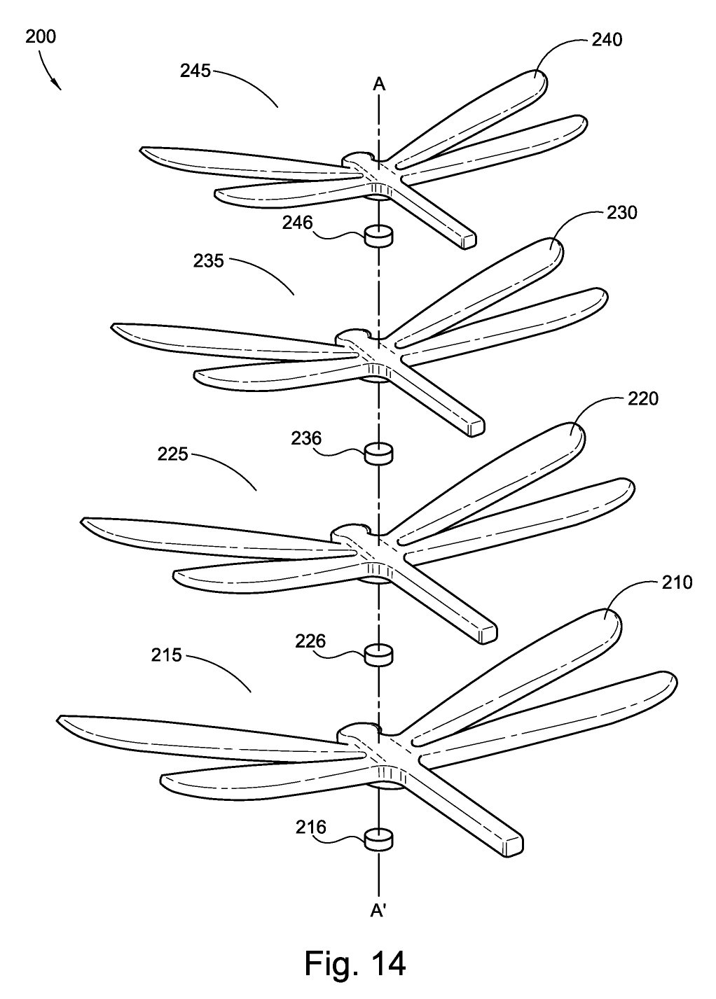

FIG. 14 shows the plurality of modules of magnet assembly 200 aligned along axis A-A′. As shown most clearly in FIGS. 14-16 and 18, the members of first module 210 bend in a coaxial direction and define cavity 215; the members of second module 220 bend in a coaxial direction and define cavity 225; the members of third module 230 bend in a coaxial direction and define cavity 235; and, the members of fourth module 240 bend in a coaxial direction and define cavity 245.

As shown in FIGS. 11-16, the plurality of modules of magnet assembly 200 may be stacked and nested in order of progressively decreasing size along axis A-A′. Each stacked module is nested within the cavity of the module upon which it is stacked. In particular, fourth module 240 is stacked upon third module 230 and nested within cavity 235; third module 230 is stacked upon second module 220 and nested within cavity 225; and, second module 220 is stacked upon first module 210 and nested within cavity 215.

When the modules are in a stacked and nested arrangement, the magnets of the modules are axially aligned and magnetically attracted to each other. Such magnetic attraction is preferably of sufficient strength to secure the plurality of modules in the stacked and nested arrangement.

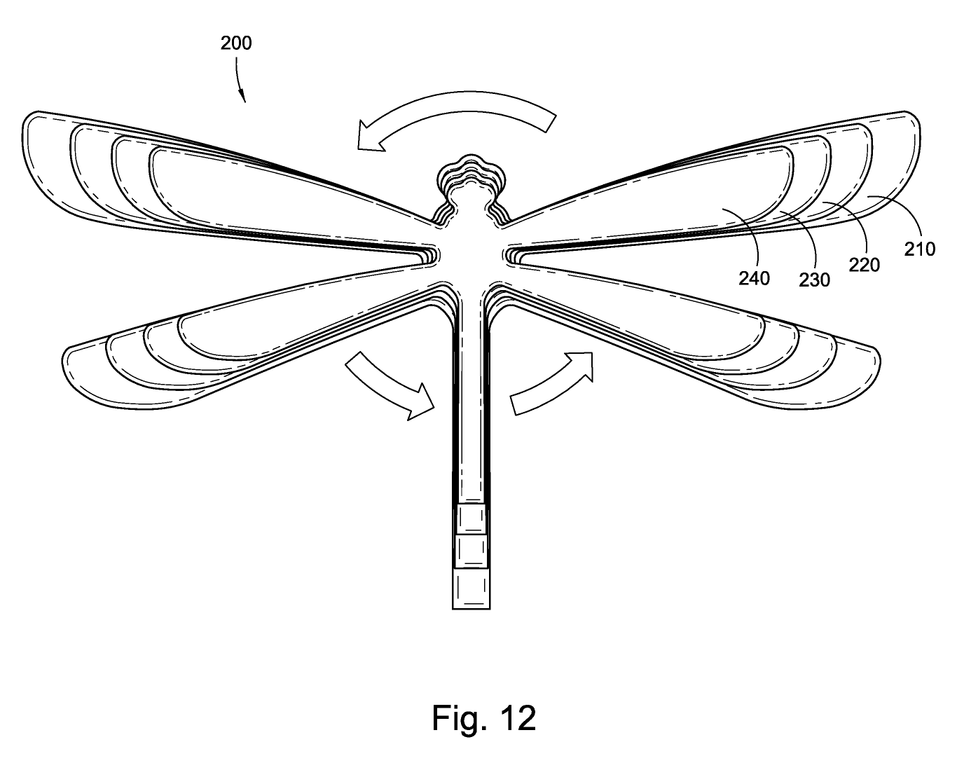

As shown in FIG. 12, the plurality of modules may be stacked and nested such that the respective members and gaps of every module are in axial alignment. As shown in FIG. 13 the plurality of modules may be stacked and nested such that various members and gaps of the modules are in axial alignment, which provides magnet assembly 200 with the appearance of a flower. Preferably, as indicated with the arrows in FIG. 12, modules 210, 220, 230, and 240 are rotatable when they are in a stacked and nested arrangement so that the members and gaps of each module may rotated in and out of alignment.

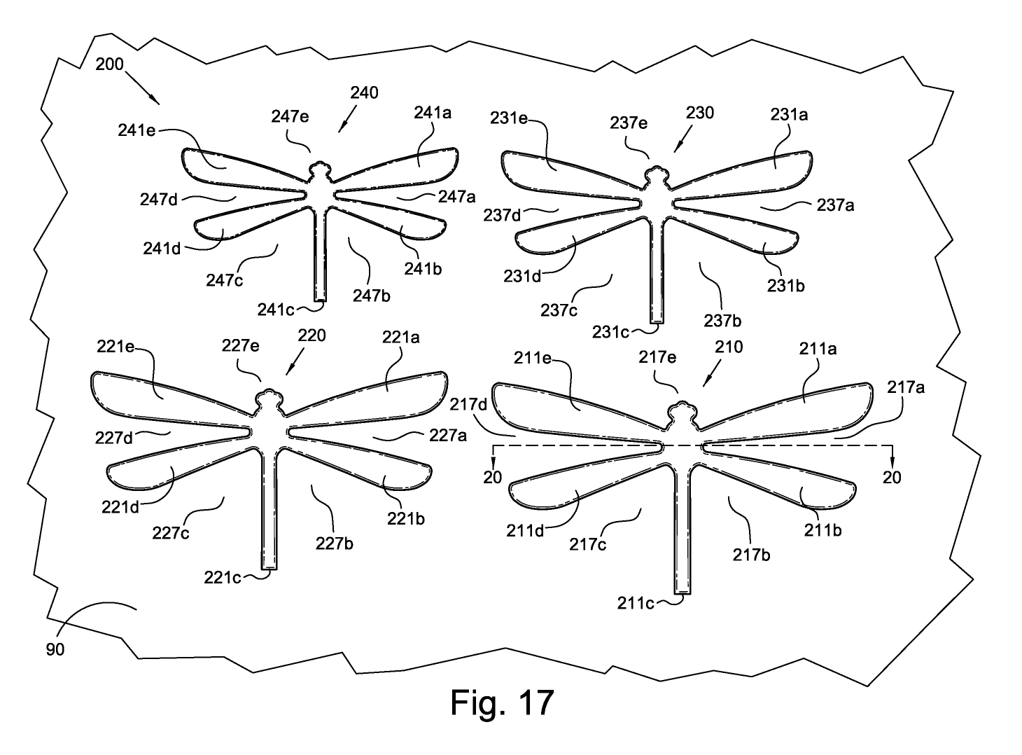

As shown in FIGS. 17-19, first module 210 comprises first plurality of members 211a-d, and first plurality of gaps 217a-d defined therebetween, extending radially from first magnet 216, which is arranged in the center of first module 210. As shown in the figures, each member of first plurality of members 211a-d includes a proximal end affixed to first magnet 216 and a distal end arranged opposite the proximal end. Additionally, first plurality of members 211a-d are petal-shaped and/or wing-shaped, and bent in a coaxial direction as they extend from first magnet 216. Such bending of first plurality of members 211a-d provides a generally concave top surface, which defines first cavity 215, and a convex bottom surface. In the embodiment shown in the figures, first magnet 216 is affixed to the proximal ends of first plurality of members 211a-d on the convex bottom surface.

Second module 220 comprises second plurality of members 221a-d, and second plurality of gaps 227a-d defined therebetween, extending radially from second magnet 226, which is arranged in the center of second module 220. As shown in the figures, each member of second plurality of members 221a-d includes a proximal end affixed to second magnet 226 and a distal end arranged opposite the proximal end. Additionally, second plurality of members 221a-d are preferably petal-shaped and/or wing-shaped, and bent in a coaxial direction as they extend from second magnet 226. Such bending of second plurality of members 221a-d provides a generally concave top surface, which defines second cavity 225, and a convex bottom surface. In the embodiment shown in the figures, second magnet 226 is affixed to the proximal ends of second plurality of members 221a-d on the convex bottom surface.

Third module 230 module comprises third plurality of members 231a-d, and third plurality of gaps 237a-d defined therebetween, extending radially from third magnet 236, which is arranged in the center of third module 230. As shown in the figures, each member of third plurality of members 231a-d includes a proximal end affixed to third magnet 236 and a distal end arranged opposite the proximal end. Additionally, third plurality of members 231a-d are preferably petal-shaped and/or wing-shaped, and bent in a coaxial direction as they extend from third magnet 236. Such bending of third plurality of members 231a-d provides a generally concave top surface, which defines third cavity 235, and a convex bottom surface. In the embodiment shown in the figures, third magnet 236 is affixed to the proximal ends of third plurality of members 231a-d on the convex bottom surface.

Fourth module 240 comprises fourth plurality of members 241a-d, and fourth plurality of gaps 247a-d defined therebetween, extending radially from fourth magnet 246, which is arranged in the center of fourth module 240. As shown in the figures, each member of fourth plurality of members 241a-d includes a proximal end affixed to fourth magnet 246 and a distal end arranged opposite the proximal end. Additionally, fourth plurality of members 241a-d are preferably petal-shaped and/or wing-shaped, and bent in a coaxial direction as they extend from fourth magnet 246. Such bending fourth plurality of members 241a-d provides a generally concave top surface, which defines fourth cavity 245, and a convex bottom surface. In the embodiment shown in the figures, fourth magnet 246 is affixed to the proximal ends of fourth plurality of members 241a-d on the convex bottom surface.

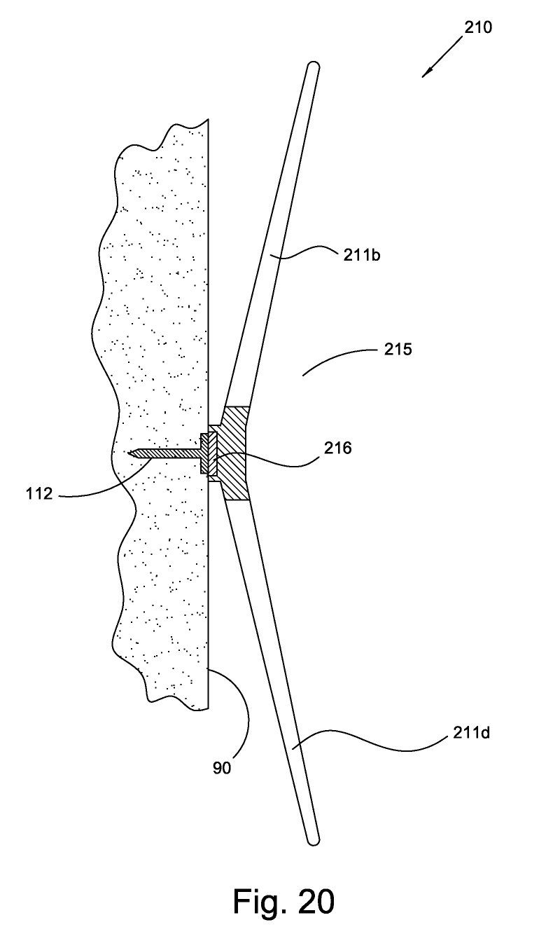

As magnet assembly 200 comprises a plurality of separate modules, each of which includes a magnet from which its members extend, each module may be secured to a surface by means of magnetic attraction between the magnet and the surface. For example, as shown in FIG. 17, first module 210, second module 220, third module 230, and fourth module 240 are each secured to vertical surface 90 by means of a magnetic attraction between first magnet 216, second magnet 226, third magnet 236, and fourth magnet 246, respectively, and a nail embedded in vertical surface 90, which nail comprises a magnetically attractable material, such as iron. For example, as shown in FIG. 20, first module 200 is secured to vertical surface 90 by means of a magnetic attraction between first magnet 216 and nail 112.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

What is claimed is:

1. A modular magnet assembly comprising:
a first module comprising a first whorl of members extending from a first magnet and defining a first cavity; and,
a second module comprising a second whorl of members extending from a second magnet and defining a second cavity, wherein the second module is stackable on the first module such that the second whorl is nested within the first cavity and the first magnet and the second magnet are aligned along an axis, and the first magnet and the second magnet are operatively arranged to magnetically secure the second module to the first module when the second whorl is nested within the first cavity.

2. The modular magnet assembly as recited in claim 1 wherein the first whorl of members comprises a first plurality of members defining a first plurality of gaps therebetween, and the second whorl of members comprises a second plurality of members, the second plurality of members being alignable with either the first plurality of members or the first plurality of gaps, when the second whorl is nested within the first cavity.

3. The modular magnet assembly as recited in claim 1 wherein the second whorl is rotatable within the first cavity about the axis.

4. The modular magnet assembly as recited in claim 1 wherein at least one member of the first plurality of members is petal-shaped and/or wing-shaped.

5. The modular magnet assembly as recited in claim 4 wherein the first module is in the form of a dragonfly.

6. The modular magnet assembly as recited in claim 6 wherein the first module is in the form of a dragonfly.

7. The modular magnet assembly as recited in claim 3 wherein the first module and the second module are each in the form of a dragonfly.

8. A modular magnet assembly comprising:
a first module comprising a first magnet and a first cavity; and,
a second module comprising a second magnet and a second cavity, wherein the second module is stackable on the first module such that the second module is nested within the first cavity and the first magnet and the second magnet are aligned along an axis, and the first magnet and the second magnet and operatively arranged to magnetically secure the second module to the first module when the second module is nested within the first cavity.

9. The modular magnet assembly recited in claim 8 wherein the first module comprises a first plurality of members arranged as a first whorl, the second module comprises a second plurality of members arranged as a second whorl.

10. The modular magnet assembly as recited in claim 9 wherein at least one member of the first plurality of members is petal-shaped and/or wing-shaped.

11. The modular magnet assembly as recited in claim 10 wherein at least one member of the second plurality of members is petal-shaped and/or wing-shaped.

12. The modular magnet assembly as recited in claim 9 wherein the first module and the second module are each in the form of a dragonfly.

13. The modular magnet assembly as recited in claim 9 wherein the first plurality of members defines a first plurality of gaps therebetween, and the second plurality of members are axially alignable with either the first plurality of members or the first plurality of gaps when the second module is nested within the first cavity.

14. The modular magnet assembly as recited in claim 9 wherein the second module is rotatable within the first cavity.
